(19) United States
(12) Patent Application Publication
(10) Pub. No.: US 2012/0188672 A1
(43) Pub. Date: Jul. 26, 2012

(54) PRINTED WIRING BOARD

(75) Inventors: Keita TAKANASHI, Tokyo (JP); Hiroshi MORIDERA, Sayama-shi (JP)

(73) Assignees: SANYO OPTEC DESIGN CO., LTD., Gunma-ken (JP); SANYO ELECTRIC CO., LTD., Osaka (JP)

(21) Appl. No.: 13/351,025

(22) Filed: Jan. 16, 2012

(30) Foreign Application Priority Data
Jan. 20, 2011 (JP) 2011-009338

(51) Int. Cl. H02H 9/02

(52) U.S. Cl. 361/57

(57) ABSTRACT

A printed wiring board includes: a first-electrostatic-discharge-protecting pattern having a first anode pattern electrically connect to an anode of a laser diode and a first cathode pattern arranged to oppose the first anode pattern and electrically connect to a cathode of the laser diode; and a second-electrostatic-discharge-protecting pattern having a second anode pattern electrically connect to the anode of the laser diode and a second cathode pattern arranged to oppose the second anode pattern and electrically connect to the cathode of the laser diode, wherein the first-electrostatic-discharge-protecting pattern has a first soldering area at which solder is melted by a soldering iron such that the first anode and cathode patterns are short-circuited or short-circuit-released, and the second-electrostatic-discharge-protecting pattern has a second soldering area at which the solder is melted by a reflow such that the second anode and cathode patterns are short-circuited or short-circuit-released.

### CROSS-REFERENCE TO RELATED APPLICATION

This application claims the benefit of priority to Japanese Patent Application No. 2011-009338, filed Jan. 20, 2011, of which full contents are incorporated herein by reference.

### BACKGROUND OF THE INVENTION

1. Field of the Invention

The present invention relates to a printed wiring board to be used in an optical pickup apparatus configured to perform an operation of reading a signal recorded in an optical disc using a laser beam.

2. Description of the Related Art

Optical disc devices are in widespread use that are capable of performing an operation of reproducing a signal and an operation of recording a signal by irradiating a signal recording layer of an optical disc with a laser beam emitted from an optical pickup apparatus.

While the optical disc device which uses the optical disc called CD or DVD is in general use, the optical disc device which uses the optical disc with recording density thereof improved, namely, a Blu-ray optical disc, has recently been developed.

The optical pickup apparatus is configured to condense the laser beam emitted from a laser diode onto a signal recording layer included in the optical disc by a focusing operation of an object lens, as well as irradiate a photodetector with return light, which is the laser beam reflected from the signal recording layer.

The optical disc device has been commercialized that is capable of using all the optical discs of the CD-standard optical disc, the DVD-standard optical disc, and the Blu-ray-standard optical disc described above, and the optical pickup apparatus, which is used in such an optical disc device, is configured to be able to perform an operation of reading a signal recorded in all the optical discs.

Such an optical pickup apparatus includes the laser diode which is configured to generate and emit a first laser beam, a second laser beam, and a third laser beam having different wavelengths, and such a laser diode generally includes: a laser diode configured to emit the laser beam to read a signal recorded in the Blu-ray-standard optical disc; and a so-called two-wavelength laser diode, in which a first laser diode configured to emit the laser beam to read a signal recorded in the CD-standard optical disc and a second laser diode configured to emit the laser beam to read a signal recorded in the DVD-standard optical disc are incorporated in a single housing.

The laser diode included in the optical pickup apparatus, which is configured to perform the operation of reading a signal recorded in the optical disc, has a problem of being damaged by static electricity. In order to protect the laser diode from such an electrostatic discharge, generally used is a method that a printed wiring board to be incorporated in the optical pickup apparatus is provided with a short-circuit-use land for short-circuiting a power supply terminal and a ground terminal of the laser diode and the power supply terminal and the ground terminal are being short-circuited until when the optical pickup apparatus is incorporated into the optical disc device. Such a technique includes a technique disclosed in Japanese Laid-Open Patent Publication No. 2007-193921.

The technique of protecting the laser diode from the electrostatic discharge will be described with reference to FIGS. 4A and 4B. FIG. 4A is an explanatory diagram of a relationship between a pattern wired on the printed wiring board and the laser diode, and for example, an anode pattern 2 connected to an anode which is a power supply terminal of a laser diode 1 and a cathode pattern 3 connected to a cathode which is a ground terminal of the laser diode 1 are provided.

In the figure, a hatched part 2A of the anode pattern 2 is a resist coating and a part thereof 2B not coated with the resist coating is an anode solder pattern which is to be soldered. Similarly, a hatched part 3A of the cathode pattern 3 is a resist coating and a part thereof 3B not coated with the resist coating is a cathode solder pattern to be soldered.

Soldering is performed in a state where a component such as the laser diode 1 is mounted on the printed wiring board on which the above-described patterns have been wired, and the soldering is generally performed by a method called reflow. The reflow is a method of fixing an electronic component to the printed wiring board, which is called surface mounting, and a configuration is such that the electronic component is mounted in a state where cream solder is coated and then the electronic component is electrically fixed by means of soldering to the patterns, formed on the printed wiring board, by applying high temperature treatment thereto.

FIG. 4B depicts a state where the electronic component is fixed onto the printed wiring board by a reflow operation, and reference numeral 4 denotes the cream solder. That is to say, as is apparent from the figure, a state is such that the anode solder pattern 2B and the cathode solder pattern 3B are electrically connected by the cream solder 4, i.e., a state where they are short-circuited. The cream solder 4 acts as the solder for short-circuit.

In such a state, since the anode that is the power supply terminal of the laser diode 1 and the cathode that is the ground terminal thereof are short-circuited, which results in a sate where the laser diode 1 can be protected from the electrostatic discharge.

In such a state, in the case where an operation of adjusting the optical pickup apparatus is performed by supplying a drive signal to the laser diode 1 or in the case where an operation of assembling it to the optical disc device is to be completed, it is required to release the state where the anode and the cathode of the laser diode 1 are short-circuited. Such an operation is performed by fusing the cream solder 4 as the above-described solder for short circuit with a soldering iron, etc., to separate the anode solder pattern 2B and the cathode solder pattern 3B as illustrated in FIG. 4A.

In the optical pickup apparatus, it is necessary to perform an operation of releasing short-circuit to change a state from a short-circuit state illustrated in FIG. 4B to a non-short-circuit state illustrated in FIG. 4A by fusing and removing the cream solder 4, and an operation of short-circuiting to change a state from the non-short-circuit state illustrated in FIG. 4A to the short-circuit state illustrated in FIG. 4B by fusing and applying the cream solder 4.

The operation of short-circuiting the anode solder pattern 2B and the cathode solder pattern 3B and the operation of releasing the short-circuit thereof are to be performed at least three times, i.e., at the time of assembling the optical pickup apparatus, at the time of performing an optical adjustment, and at the time of incorporating it into an optical disc device, as described in Japanese Laid-Open Patent Publication No. 2007-193921.

While the short-circuiting operation and the short-circuit releasing operation are performed with the soldering iron, etc., heat resistance is required to perform such operations, and therefore the anode solder pattern 2B and the cathode solder pattern 3B are required to have a certain size. In a case where the anode solder pattern 2B and the cathode solder pattern 3B are of large size, the amount of the cream solder required for short-circuiting these patterns by the reflow operation is increased, and as a result, there are such problems that not only does a short-circuit error caused by a reflow solder occur but also the cost of manufacturing is increased.

### SUMMARY OF THE INVENTION

A printed wiring board according to an aspect of the present invention, includes: a first electrostatic discharge protecting pattern having a first anode pattern electrically connect to an anode of a laser diode and a first cathode pattern arranged to oppose the first anode pattern and electrically connect to a cathode of the laser diode; and a second electrostatic discharge protecting pattern having a second anode pattern electrically connect to the anode of the laser diode and a second cathode pattern arranged to oppose the second anode pattern and electrically connect to the cathode of the laser diode, wherein the first electrostatic discharge protecting pattern has a first soldering area at which solder is melted by a soldering iron such that the first anode pattern and the first cathode pattern are short-circuited or short-circuit-released, and the second electrostatic discharge protecting pattern has a second soldering area at which the solder is melted by a reflow such that the second anode pattern and the second cathode pattern are short-circuited or short-circuit-released.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1A is an explanatory diagram illustrating a first embodiment of a printed wiring board according to the present invention;

FIG. 1B is an explanatory diagram illustrating a first embodiment of a printed wiring board in an other state according to the present invention;

FIG. 2 is an explanatory diagram illustrating a second embodiment of a printed wiring board according to the present invention;

FIG. 3 is an explanatory diagram illustrating a third embodiment of a printed wiring board according to the present invention;

FIG. 4A is an explanatory diagram illustrating a printed wiring board; and

FIG. 4B is an explanatory diagram illustrating a printed wiring board in an other state.

### DETAILED DESCRIPTION OF THE INVENTION

At least the following details will become apparent from descriptions of this specification and of the accompanying drawings.

A printed wiring board according to an embodiment of the present invention has an electrostatic discharge protecting pattern including an anode pattern and a cathode pattern arranged close to each other, the anode pattern connected to an anode of a laser diode and the cathode pattern connected to a cathode of the laser diode and grounded, and a reflow electrostatic discharge protecting pattern including an anode pattern and a cathode pattern arranged close to each other and having the two patterns short-circuited by a reflow solder, the anode pattern connected to the anode of the laser diode and the cathode pattern connected to the cathode of the laser diode.

A printed wiring board according to an embodiment of the present invention has an electrostatic discharge protecting pattern including a first anode pattern, a second anode pattern and a cathode pattern arranged close to each other, the first anode pattern connected to an anode of a first laser diode, a second anode pattern connected to an anode of a second laser diode, and a cathode pattern connected to a cathode of the first laser diode and a cathode of the second laser diode and grounded, a first reflow electrostatic discharge protecting pattern including an anode pattern and a cathode pattern arranged close to each other and having the two patterns short-circuited by a reflow solder, the anode pattern connected to the anode of the first laser diode and the cathode pattern connected to the cathode of the first laser diode, and a second reflow electrostatic discharge protecting pattern including an anode pattern and a cathode pattern arranged close to each other and having the two patterns short-circuited by a reflow solder, the anode pattern connected to the anode of the second laser diode and the cathode pattern connected to the cathode of the second laser diode and grounded are arranged close to each other.

In the printed wiring board according to an embodiment of the present invention has the cathode pattern configuring the electrostatic discharge protecting pattern arranged between the first anode pattern and the second anode pattern.

In the printed wiring board according to an embodiment of the present invention has soldering parts each in a fan-like form of the first anode pattern, the second anode pattern, and the cathode pattern configuring the electrostatic discharge protecting pattern, the three soldering parts arranged in a circular form.

In the printed wiring board according to an embodiment of the present invention has the area used for soldering of the reflow electrostatic discharge protecting pattern smaller than that used for soldering of the electrostatic discharge protecting pattern. For example, the area of the reflow electrostatic discharge protecting pattern is set to half or less with respect to the area of the electrostatic discharge protecting pattern. The printed wiring board according to an embodiment of the present invention allows to not only reduce the amount of cream solder used in reflow soldering but also perform short-circuiting by cream solder reliably, since a reflow electrostatic discharge protecting pattern is arranged in addition to an electrostatic discharge protecting pattern to protect the laser diode from electrostatic discharge, that is, a special pattern preventing electrostatic discharge has been arranged on the printed wiring board by reflow soldering. Further, an electrostatic discharge protecting pattern is arranged in addition to a reflow electrostatic discharge protecting pattern used in reflow soldering so that short-circuit operation and short-circuit release operation performed during optical adjustment or when assembling to an optical disc device can be done easily.

The printed wiring board according to an embodiment of the present invention has an advantage of simplifying the wiring pattern by use of a single pattern where the cathode pattern is soldered to a first anode pattern and the second anode pattern is connected to the anodes of the laser diodes as in a two-wavelength laser diode.

The printed wiring board according to an embodiment of the present invention has an advantage of allowing to reduce the amount of solder for a short-circuiting purpose as well as ease the short-circuit releasing operation, since the first anode pattern, the second anode pattern, and the cathode pattern each are in a fan-like form with the three patterns arranged circularly, allowing all the patterns to be short-circuited by soldering the central part thereof.

In an embodiment of the present invention optimum size setting of each pattern, the optimum distance setting between the anode pattern and the cathode pattern, optimum pattern setting at an easy-to-reflow-solder location on the wiring board, etc. are respectively possible since the soldering iron pattern and the reflow soldering pattern are independent of each other. Further, reliable connection by reflow soldering is possible since the distance between the anode pattern and the cathode pattern in a reflow soldering pattern can be set independently of the soldering iron pattern, and the patterns can be set at locations on the wiring board that allow easy reflow soldering.

The following first to third embodiments will be explained with respect to the printed wiring board on which anode and cathode patterns are arranged to protect the laser diode that radiates laser beams from the electrostatic discharge.

### First Embodiment

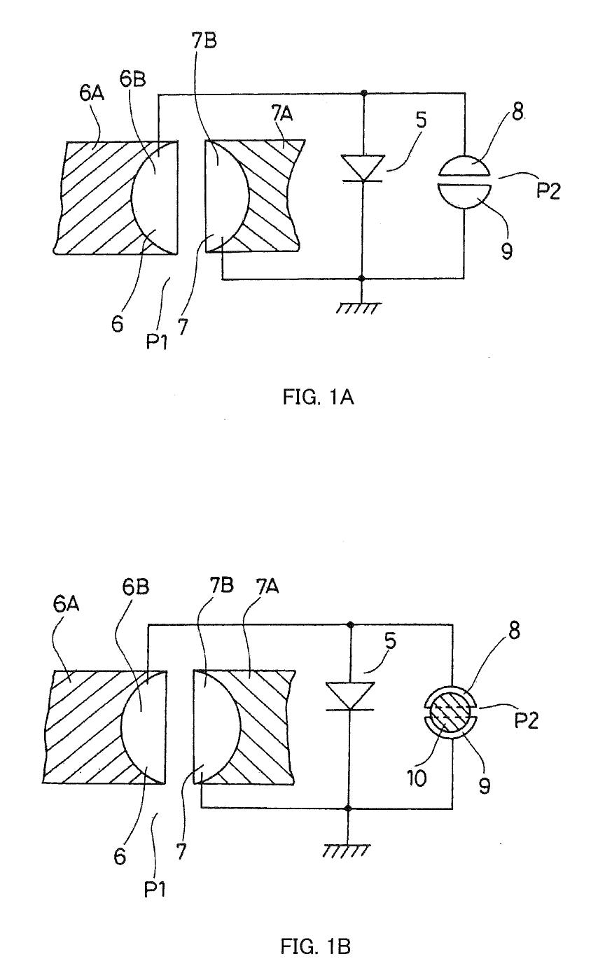

FIGS. 1A and 1B are explanatory diagrams of the first embodiment of the printed wiring board of the present embodiment which is included in the optical pickup device.

FIG. 1A is an explanatory diagram showing relationship of a pattern wired on the printed wiring board and a laser diode, and the printed wiring board is provided with an anode pattern 6 connected to an anode that is a power supply terminal of a laser diode 5 and a cathode pattern 7 connected to a cathode that is a ground terminal of the laser diode 5, for example.

In the figures, the hatched part 6A of the anode pattern 6 is a resist coating and a part thereof 6B not coated with the resist coating is an anode solder pattern which is to be soldered (first soldering area). Similarly, the hatched part 7A of the cathode pattern 7 is a resist coating and the part thereof 7B not coated with the resist coating is a cathode solder pattern to be soldered (first soldering area).

In the present embodiment, a reflow electrostatic discharge protecting pattern P2 is provided in addition to an electrostatic discharge protecting pattern P1 including the anode pattern 6 and the cathode pattern 7. The reflow electrostatic discharge protecting pattern P2 includes an anode pattern 8 (second soldering area) connected to the anode of the laser diode 5 and a cathode pattern 9 (second soldering area) connected to the cathode thereof.

In such configuration, the pattern area to be used for soldering the reflow electrostatic discharge protecting pattern P2 is set smaller than that to be used for soldering the electrostatic discharge protecting pattern P1. That is to say, the pattern area to be used for soldering the electrostatic discharge protecting pattern P1 is set to a size (for example, about φ1.5 mm) that facilitates short-circuit release operation and the short-circuiting operation using soldering iron and the pattern area to be used for soldering the reflow electrostatic discharge protecting pattern P2 is set to an area (for example, about φ1.0 mm) that enables reliable soldering in a reflow soldering operation.

The reflow electrostatic discharge protecting pattern P2 is provided on the opposite side of the electrostatic discharge protecting pattern P1 of the laser diode 5.

Soldering is performed in a state where a component such as the laser diode 5 is mounted on the printed wiring board on which the above-described patterns have been wired, and the soldering is performed by a method called reflow in an embodiment of the present invention as well. The reflow soldering is a method of fixing an electronic component to the printed wiring board, which is called surface mounting, and a configuration is such that the electronic component is mounted in a state where cream solder is coated and then the electronic component is electrically fixed by means of soldering to the patterns formed on the printed wiring board, by applying high temperature treatment thereto.

In the printed wiring board according to the present embodiment, while cream solder 10 is coated on the reflow electrostatic discharge protecting pattern P2, the cream solder is never coated on the electrostatic discharge protecting pattern P1.

FIG. 1B depicts a state where the electronic component is fixed onto the printed wiring board by reflow soldering operation, and the hatched part 10 of the reflow electrostatic discharge protecting pattern P2 is the cream solder. That is to say, as is apparent from the figure, a state is such that the anode pattern 8 and the cathode pattern 9 are electrically connected by the cream solder 10, i.e., a state where they are short-circuited. The cream solder 10 acts as the solder for short-circuiting.

In such a state, the anode (electrode supplied with a drive signal) that is the power supply terminal of the laser diode 5 and the cathode that is the ground terminal thereof are short-circuited, which results in a state where the laser diode 5 can be protected from electrostatic discharge.

In such a state, when an operation of adjusting the optical pickup apparatus is performed by supplying a drive signal to the laser diode 5 or when an operation of assembling the optical pickup device to the optical disc device is to be completed, it is required to release the short-circuited state between the anode and the cathode of the laser diode 5. Such an operation is performed by fusing with the soldering iron, etc. the cream solder 10 that had kept the anode pattern 8 and the cathode pattern 9 configuring the reflow electrostatic discharge protecting pattern P2 in a short-circuited state, to separate the anode pattern 8 and the cathode pattern 9 as illustrated in FIG. 1A.

The state illustrated in FIG. 1A represents a non-short-circuit state where an operation of adjusting the optical pickup device can be performed by supplying a drive signal to the laser diode 5. The optical pickup device is shipped after completion of such adjusting operation of the optical pickup device, and operation for protecting the laser diode 5 from electrostatic discharge is performed in the case of such shipping.

Such operation for protecting the laser diode 5 from electrostatic discharge is performed by short-circuiting the anode solder pattern 6B and the cathode solder pattern 7B configuring the electrostatic discharge protecting pattern P1 with a solder. Such short-circuiting operation is performed by fusing the solder with soldering iron. The optical pickup device can be shipped with the laser diode 5 protected from electrostatic discharge since the anode solder pattern 6B and the cathode solder pattern 7B can be short-circuited by a fusing operation of the solder with a soldering iron.

While short-circuit release operation is performed when assembling to the optical disc device the optical pickup device protected from electrostatic discharge, such short-circuit release operation is performed by fusing the solder, with the soldering iron, keeping a short-circuit state between the anode solder pattern 6B and the cathode solder pattern 7B configuring the electrostatic discharge protecting pattern P1. Such solder fusing operation and solder removing operation allows the electrostatic discharge protecting pattern P1 to be in a non-short-circuit state.

Short-circuiting operation for electrostatic discharge protection and short-circuit release operation are performed by soldering operation and solder removing operation with a soldering iron to the electrostatic discharge protecting pattern P1 as described above, therefore problems of such as damaging the patterns on the printed wiring board by heat or adversely affecting the electronic parts would not occur.

### Second Embodiment

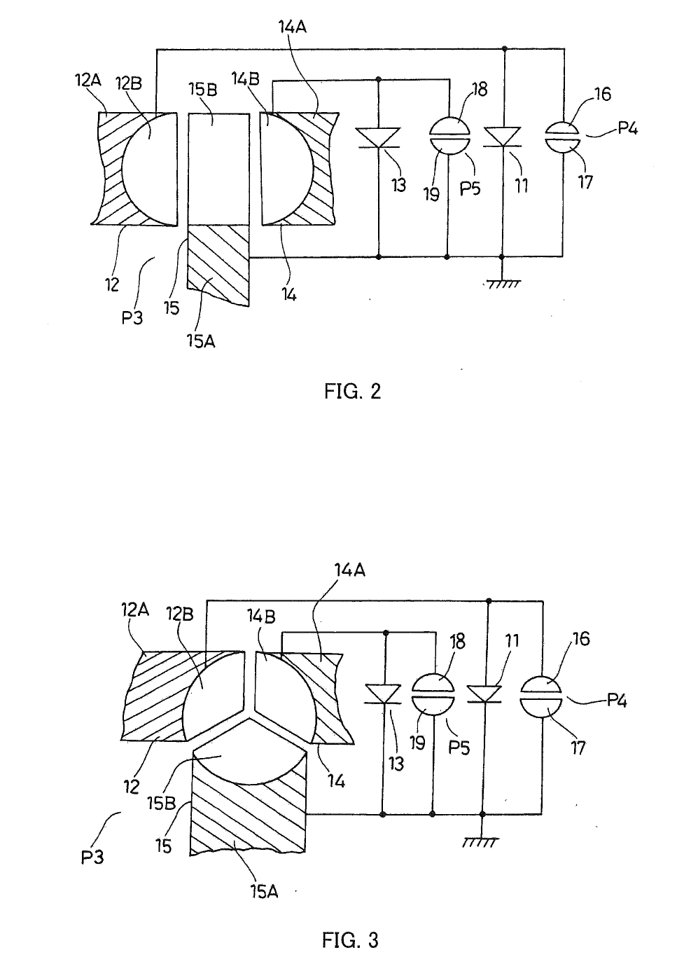

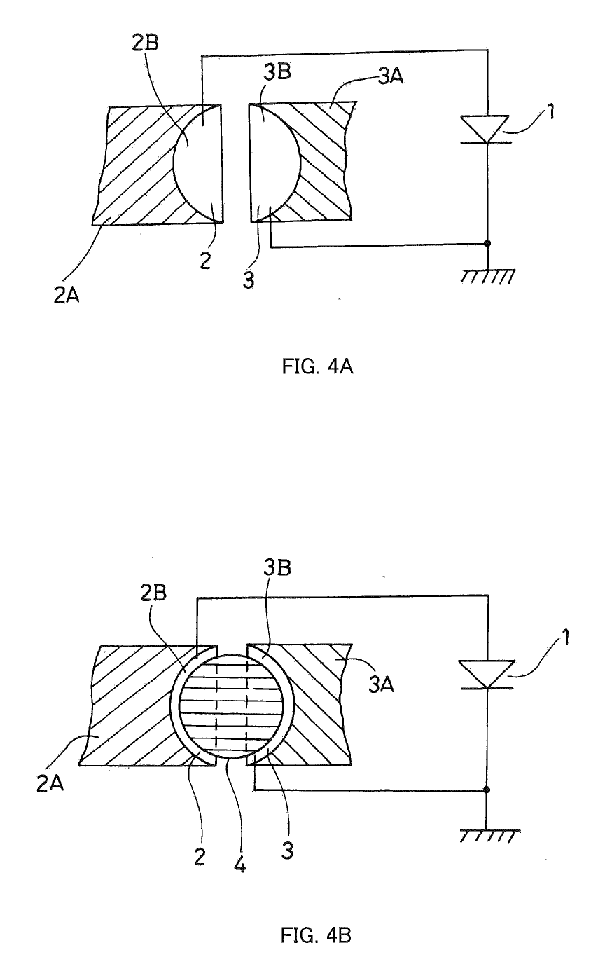

FIG. 2 depicts an example in the case where the printed wiring board of the present embodiment is implemented with respect to a two-wavelength laser diode in which two laser diodes are provided within one housing.

The printed wiring board depicted in FIG. 2 is provided with a first anode pattern 12 connected to an anode which is a power supply terminal of a first laser diode 11, a second anode pattern 14 connected to an anode a that is a power supply terminal of a second laser diode 13, and a cathode pattern 15 connected to a cathode that is a ground terminal of the first laser diode 11 as well as connected to a cathode that is a ground terminal of the second laser diode 13.

In the figure, the hatched part 12A of the first anode pattern 12 is a resist coating and the part 12B thereof not coated with the resist coating is a first anode solder pattern which is to be soldered. Similarly, the hatched part 14A of the second anode pattern 14 is the resist coating and the part 14B thereof not coated with the resist coating is a second anode solder pattern which is to be soldered. The hatched part 15A of the cathode pattern 15 is the resist film and the resist-film-less part 15B thereof is a cathode solder pattern to be soldered.

An electrostatic discharge protecting pattern P3 has a first soldering area (12B and 15B) and a second soldering area (14B and 15B), the first soldering area being an area at which melting of the solder is performed with soldering iron such that the anode pattern 12 and the cathode pattern 15 are short-circuited or short-circuit-released, and a second soldering area being an area at which melting of the solder is performed with soldering iron such that the anode pattern 14 and the cathode pattern 15 are short-circuited or short-circuit-released.

A first reflow electrostatic discharge protecting pattern P4 has a third soldering area (16 and 17) at which melting of the solder is performed by reflow soldering so that the anode pattern 16 and the cathode pattern 17 are short-circuited or short-circuit-released.

A second reflow electrostatic discharge protecting pattern P5 has a fourth soldering area (18 and 19) at which melting of the solder is performed by reflow soldering so that the anode pattern 18 and the cathode pattern 19 are short-circuited or short-circuit-released.

The second reflow electrostatic discharge protecting pattern P5 is arranged on the opposite side of the electrostatic discharge protecting pattern P3 of the second laser diode 13 and the first reflow electrostatic discharge protecting pattern P4 is arranged on the opposite side of the electrostatic discharge protecting pattern P3 of the first laser diode 11.

In the present embodiment, the first reflow electrostatic discharge protecting pattern P4 and the second reflow electrostatic discharge protecting pattern P5 are provided in addition to the electrostatic discharge protecting pattern P3 including the first anode pattern 12, the second anode pattern 14, and the cathode pattern 15. The first reflow electrostatic discharge protecting pattern P4 is configured with an anode pattern 16 connected to the anode of the first laser diode 11 and a cathode pattern 17 connected to the cathode thereof. The second reflow electrostatic discharge protecting pattern P5 is configured with an anode pattern 18 connected to the anode of the second laser diode 13 and a cathode pattern 19 connected to the cathode thereof.

In such configuration, the pattern area to be used for soldering the first reflow electrostatic discharge protecting pattern P4 and the second reflow electrostatic discharge protecting pattern P5 is set smaller than that to be used for soldering the electrostatic discharge protecting pattern P3. That is to say, the pattern area (for example, about φ1.6×1.9 mm) to be used for soldering the electrostatic discharge protecting pattern P3 is set to a size that facilitates short-circuit releasing operation and short-circuiting operation with a soldering iron and the pattern area (for example, about φ1.0 mm) to be used for the soldering the first reflow electrostatic discharge protecting pattern P4 and the second reflow electrostatic discharge protecting pattern P5 is set to an area that enables reliable soldering in a reflow soldering operation.

Soldering is performed in a state where a component such as a two-wavelength laser diode is mounted on the printed wiring board on which the above-described patterns have been wired, and the soldering is performed by a method called reflow in the embodiment of the present invention as well. The reflow is a method of fixing an electronic component to the printed wiring board, which is called surface mounting, and the configuration is such that the electronic component is mounted in a state where cream solder is coated and then the electronic component is electrically fixed by means of soldering to the patterns, formed on the printed wiring board, by applying high temperature treatment thereto.

In the printed wiring board of the present embodiment, while the cream solder is coated on the first reflow electrostatic discharge protecting pattern P4 and the second reflow electrostatic discharge protecting pattern P5, the cream solder is never coated on the electrostatic discharge protecting pattern P3.

When such soldering is performed, the anode solder pattern 16 and the cathode pattern 17 configuring the first reflow electrostatic discharge protecting pattern P4, and the anode pattern 18 and the cathode pattern 19 configuring the second reflow electrostatic discharge protecting pattern P5, are in an electrically connected state, namely, in a short-circuited state by the cream solders.

In such a state, the anode (the electrode supplied with a drive signal) that is the power supply terminal of the first laser diode 11 and the cathode that is the ground terminal thereof are short-circuited, which results in a state where the first laser diode 11 can be protected from the electrostatic discharge. Similarly, the anode (the electrode supplied with a drive signal) that is the power supply terminal of the second laser diode 13 and the cathode that is the ground terminal thereof are short-circuited, which results in a state where the second laser diode 13 can be protected from electrostatic discharge.

In such a state, when an operation of adjusting the optical pickup apparatus is performed by supplying a drive signal to the first laser diode 11 and the second laser diode 13 or when an operation of assembling the optical pickup device to the optical disc device is to be completed, it is required to release the state where the anodes and the cathodes of the first laser diode 11 and the second laser diode 13 are short-circuited. Such short-circuit releasing operation is performed by an operation of fusing the cream solder creating a short-circuit state between the anode pattern 16 and the cathode pattern 17 configuring the first reflow electrostatic discharge protecting pattern P4 with a soldering iron, etc., to release the short-circuit state between the anode pattern 16 and the cathode pattern 17, and by an operation of fusing the cream solder creating a short-circuit state between the anode pattern 18 and the cathode pattern 19 configuring the second reflow electrostatic discharge protecting pattern P5 with a soldering iron, etc., to release the short-circuit state between the anode pattern 18 and the cathode pattern 19.

In the state where the short-circuit state releasing operation has been performed, the adjusting operation of the optical pickup device can be performed by supplying a drive signal to the first laser diode 11 and the second laser diode 13. The optical pickup device is shipped after completion of such adjusting operation of the optical pickup device, and an operation for protecting the first laser diode and the second laser diode 13 from electrostatic discharge is performed in the case of such shipping.

Such operation to protect the first laser diode 11 and the second laser diode 13 from electrostatic discharge is performed by short-circuiting the first anode solder pattern 12B and the cathode solder pattern 15B configuring the electrostatic discharge protecting pattern P3 with a solder as well as short-circuiting the second anode solder pattern 14B and the cathode solder pattern 15B with a solder.

Such short-circuiting operation is performed by fusing the solder with a soldering iron. And such fusing operation on the solder with the soldering iron allows to short-circuit the first anode solder pattern 12B and the cathode solder pattern 15B as well as short-circuit the second anode solder pattern 14B and the cathode solder pattern 15B, enabling the optical pickup device to be shipped with the first laser diode 11 and the second laser diode 13 protected from electrostatic discharge.

While short-circuit releasing operation is performed when assembling to the optical disc device the optical pickup device protected from electrostatic discharge, such short-circuit releasing operation is performed by fusing the solder creating a short-circuit state between the first anode solder pattern 12B and the cathode solder pattern 15B configuring the electrostatic discharge protecting pattern P3 with a soldering iron along with fusing the solder creating a short-circuit state between the second anode solder pattern 14B and the cathode solder pattern 15B with a soldering iron. Such solder fusing operation and solder removing operation allows the electrostatic discharge protecting pattern P3 to be in a non-short-circuit state.

Short-circuiting operation for electrostatic discharge protection and short-circuit release operation are performed by soldering operation and solder removing operation with a soldering iron to the electrostatic discharge protecting pattern P3 as described above, therefore problems of such as damaging the patterns on the printed wiring board by heat or adversely affecting the electronic parts would not occur.

An embodiment of the present invention, in which the cathode solder pattern 15B is arranged between the first anode solder pattern 12B and the second anode solder pattern 14B, has an advantage that the cathode solder pattern 15B is capable of being used as an electrostatic discharge protecting pattern by both diodes.

### Third Embodiment

FIG. 3 depicts another example where the printed wiring board is implemented with respect to the two-wavelength laser diode in which two laser diodes are provided within one housing. Components equivalent to those illustrated in the second embodiment according to the present invention are designated by the same reference numerals.

As illustrated, the third embodiment is characterized in that the first anode solder pattern 12B of the first anode pattern 12, the second anode solder pattern 14B of the second anode pattern 14, and the cathode solder pattern 15B of the cathode pattern 15 each are shaped in a fan-like form and that the first anode solder pattern 12B, the second anode solder pattern 14B, and the cathode solder pattern 15B are arranged in a circular form.

Soldering is performed in a state where a component such as the two-wavelength laser diode is mounted on the printed wiring board on which the above-described patterns have been wired, and the soldering is performed by a method called reflow in an embodiment of the present invention as well.

In the printed wiring board of the present embodiment, while cream solder is coated on the first reflow electrostatic discharge protecting pattern P4 (for example, about φ1.0 mm) and the second reflow electrostatic discharge protecting pattern P5 (for example, about φ1.0 mm), the cream solder is never coated on the electrostatic discharge protecting pattern P3 (for example, about φ1.8 mm).

When such reflow soldering has been performed, the anode pattern 16 and the cathode pattern 17 configuring the first reflow electrostatic discharge protecting pattern P4 and the anode pattern 18 and the cathode pattern 19 configuring the second reflow electrostatic discharge protecting pattern P5 are electrically connected, respectively, namely, short-circuited by the cream solder.

In such state, the anode that is the power supply terminal of the first laser diode 11 and the cathode that is the ground terminal thereof are short-circuited, which results in a state where the first laser diode 11 can be protected from electrostatic discharge. Similarly, the anode that is the power supply terminal of the second laser diode 13 and the cathode that is the ground terminal thereof are short-circuited, which results in a state where the second laser diode 13 can be protected from electrostatic discharge.

In such a state, when an operation of adjusting the optical pickup apparatus is performed by supplying a drive signal to the first laser diode 11 and the second laser diode 13 or when an operation of assembling the optical pickup device to the optical disc device is to be completed, it is required to release the state where the anodes and the cathodes of the first laser diode 11 and the second laser diode 13 are short-circuited. Such short-circuit releasing operation is performed by fusing the cream solder creating a short-circuit state between the anode pattern 16 and the cathode pattern 17 configuring the first reflow electrostatic discharge protecting pattern P4 with a soldering iron, etc., to release the short-circuit state between the anode pattern 16 and the cathode pattern 17, and by fusing the cream solder creating a short-circuit state between the anode pattern 18 and the cathode pattern 19 configuring the second reflow electrostatic discharge protecting pattern P5 with a soldering iron, etc., to release the short-circuit state between the anode pattern 18 and the cathode pattern 19.

In the state where the short-circuit state releasing operation has been performed, the adjusting operation of the optical pickup device can be performed by supplying a drive signal to the first laser diode 11 and the second laser diode 13. The optical pickup device is shipped after completion of such adjusting operation of the optical pickup device, and an operation for protecting the first laser diode and the second laser diode 13 from electrostatic discharge is performed in the case of such shipping.

Such operation to protect the first laser diode 11 and the second laser diode 13 from electrostatic discharge is performed by short-circuiting the first anode solder pattern 12B and the cathode solder pattern 15B configuring the electrostatic discharge protecting pattern P3 with a solder as well as short-circuiting the second anode solder pattern 14B and the cathode solder pattern 15B with a solder.

Such short-circuiting operation is performed by fusing the solder with a soldering iron. And such fusing operation on the solder with the soldering iron allows to short-circuit the first anode solder pattern 12B and the cathode solder pattern 15B as well as short-circuit the second anode solder pattern 14B and the cathode solder pattern 15B, enabling the optical pickup device to be shipped with the first laser diode 11 and the second laser diode 13 protected from electrostatic discharge.

While short-circuit releasing operation is performed when assembling to the optical disc device the optical pickup device protected from electrostatic discharge, such short-circuit releasing operation is performed by fusing the solder creating a short-circuit state between the first anode solder pattern 12B and the cathode solder pattern 15B configuring the electrostatic discharge protecting pattern P3 with a soldering iron, along with fusing the solder creating a short-circuit state between the second anode solder pattern 14B and the cathode solder pattern 15B with a soldering iron. Such solder fusing operation and solder removing operation allows the electrostatic discharge protecting pattern P3 to be in a non-short-circuit state.

Short-circuiting operation for electrostatic discharge protection and short-circuit release operation are performed by soldering operation and solder removing operation with a soldering iron to the electrostatic discharge protecting pattern P3 as described above, therefore problems of such as damaging the patterns on the printed wiring board by heat or adversely affecting the electronic parts would not occur.

As illustrated, the present embodiment has each of the first anode solder pattern 12B of the first anode pattern 12, the second anode solder pattern 14B of the second anode pattern 14, and the cathode solder pattern 15B of the cathode pattern 15 shaped in a fan-like form and the first anode solder pattern 12B, the second anode solder pattern 14B, and the cathode solder pattern 15B arranged in a circular form, allowing to facilitate an effective short-circuit operation and short-circuit release operation of the first anode solder pattern 12B, the second anode solder pattern 14B and the cathode solder pattern 15B by soldering operation and solder fusing and removing operation with a solder iron at the central part thereof.

The above embodiments of the present invention are simply for facilitating the understanding of the present invention and are not in any way to be construed as limiting the present invention. The present invention may variously be changed or altered without departing from its spirit and encompass equivalents thereof.

In an embodiment of the present invention, the solder patterns not coated with resist coating are shaped in a semicircular shape, however, the shape can be changed in various ways. Further, the printed wiring board configured to protect the laser diode from electrostatic discharge has been described herein, however, it can also be implemented with respect to other electronic components having possibility of electrostatic discharge.

1. A printed wiring board comprising:
a first electrostatic discharge protecting pattern having a first anode pattern electrically connect to an anode of a laser diode and a first cathode pattern arranged to oppose the first anode pattern and electrically connect to a cathode of the laser diode; and
a second electrostatic discharge protecting pattern having a second anode pattern electrically connect to the anode of the laser diode and a second cathode pattern arranged to oppose the second anode pattern and electrically connect to the cathode of the laser diode, wherein
the first electrostatic discharge protecting pattern has a first soldering area at which solder is melted by a soldering iron such that the first anode pattern and the first cathode pattern are short-circuited or short-circuit-released, and
the second electrostatic discharge protecting pattern has a second soldering area at which the solder is melted by a reflow such that the second anode pattern and the second cathode pattern are short-circuited or short-circuit-released.

2. The printed wiring board of claim 1, wherein
the area of the second soldering area is smaller than that of the first soldering area.

3. The printed wiring board of claim 2, wherein
the second electrostatic discharge protecting pattern is arranged on the opposite side of the first electrostatic discharge protecting pattern of the laser diode.

4. The printed wiring board of claim 1, wherein
the anode of the laser diode is an electrode to be supplied with a drive signal, and wherein
the cathode of the laser diode is an electrode to be grounded.

5. A printed wiring board comprising:
a first electrostatic discharge protecting pattern having a first anode pattern electrically connected to an anode of a first laser diode, a second anode pattern electrically connected to an anode of a second laser diode, and a first cathode pattern arranged to oppose the first and the second anode patterns and electrically connect to cathodes of the first and the second laser diodes;
a second electrostatic discharge protecting pattern having a third anode pattern electrically connected to the anode of the first laser diode and a second cathode pattern arranged to oppose the third anode pattern and electrically connect to the cathode of the first laser diode; and
a third electrostatic discharge protecting pattern having a fourth anode pattern electrically connected to the anode of the second laser diode and a third cathode pattern arranged to oppose the fourth anode pattern and electrically connect to the cathode of the second laser diode, wherein
the first electrostatic discharge protecting pattern has a first soldering area at which solder is melted by a soldering iron such that the first anode pattern and the first cathode pattern are short-circuited or short-circuit-released and a second soldering area at which solder is melted by a soldering iron such that the second anode pattern and the first cathode pattern are short-circuited or short-circuit-released,
the second electrostatic discharge protecting pattern has a third soldering area at which solder is melted by a reflow such that the third anode pattern and the second cathode pattern are short-circuited or short-circuit-released, and
the third electrostatic discharge protecting pattern has a fourth soldering area at which solder is melted by a reflow such that the fourth anode pattern and the third cathode pattern are short-circuited or short-circuit-released.

6. The printed wiring board of claim 5, wherein
the first cathode pattern is arranged between the first and the second anode patterns to oppose the first and the second anode patterns.

7. The printed wiring board of claim 5, wherein
each of the first anode pattern, the second anode pattern, and the first cathode pattern is in a fan-like form, and
the first anode pattern, the second anode pattern, and the first cathode pattern are arranged to be in a circular form.

8. The printed wiring board of claim 5, wherein
each of the areas of the third and the fourth soldering areas are smaller than that of the first soldering area and that of the second soldering area, respectively.

9. The printed wiring board of claim 8, wherein
the second electrostatic discharge protecting pattern is arranged on an opposite side of the first electrostatic discharge protecting pattern of the first laser diode, and
the third electrostatic discharge protecting pattern is arranged on an opposite side of the second electrostatic discharge protecting pattern of the second laser diode.

10. The printed wiring board of claim 5, wherein
the anode of the first laser diode is an electrode to be supplied with a first drive signal,
the anode of the second laser diode is an electrode to be supplied with a second drive signal, and
the cathode of the first and the second laser diodes is an electrode to be grounded.
